(19) United States
(12) Patent Application Publication
(10) Pub. No.: US 2006/0271680 A1
(43) Pub. Date: Nov. 30, 2006

(54) Method For Transmitting Window Probe Packets

(75) Inventors: Leah Shalev, Zichron-Yaakov (IL); Giora Biran, Zichron-Yaakov (IL); Vadim Makhervaks, Austin, TX (US)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, ARMONK, NY (US)

(21) Appl. No.: 10/908,886

(22) Filed: May 31, 2005

(51) Int. Cl. G06F 15/173

(52) U.S. Cl. 709/225

(57) ABSTRACT

A system for facilitating communication between a sender computer and a recipient computer via a network, the system including a network interface (NI), a network protocol stack (NPS), a data memory for transferring data from the NPS to the NI for transmission to the recipient computer, a connection context field (CCF) for storing a byte of the data for transmission by the NI to the recipient computer as part of a window probe packet, and a decision maker for providing a sequence number associated with the byte for transmission by the NI to the recipient computer as part of the window probe packet, where said NI includes said CCF and said decision maker.

### FIELD OF THE INVENTION

The present invention relates to computer network communications in general, and more particularly to the transmission of window probe packets, such as in TCP/IP-based networks.

### BACKGROUND OF THE INVENTION

Communications using the TCP/IP communications protocol typically take place between two parties, a sender computer and a recipient computer. Typically, the sender utilizes a network protocol stack manager (NPS) to direct a network interface (NI) to facilitate TCP/IP communications. The NPS specifies the data to be transmitted, and the NI packages the data into a packet, which typically includes a sequence number of the first byte, which may also be used to indicate the sequence of the packet in a stream of packets, an indication of the number of bytes in the payload, and the payload itself. The NI may then transmit the packet to the recipient and await an acknowledgment (ACK) from the recipient. Each ACK typically includes a sequence number identifying the next byte expected to be received and an indication of the size of the recipient's receive window, which refers to the room that is available in the recipient's receive buffer for receiving additional data packets. The sender may modify the size of the transmitted packet based on the window size reported in the most recently received ACK.

The NI typically continues to transmit packets with the data specified by the NPS until the NI receives an ACK from the recipient with a window size of zero, indicating that the recipient is unable to receive more packets. At this stage the NI enters a ‘window probe mode’ and begins periodically transmitting window probe packets to the recipient with the primarily goal of eliciting an ACK from the recipient. Through this mechanism the NI polls the recipient to determine if the recipient's window size is greater than zero, which would indicate that received packets have been removed from the recipient's receive buffer since the recipient last sent an ACK with a window size of zero, and that there is now room in the receive buffer for more packets.

Typically, the NI is implemented in hardware that is separate from the hardware that hosts the software implementation of the NPS, although there are several types of NI/NPS implementations, each differing by the sophistication level of their hardware. A communication channel between the hardware NI and the software NPS is typically implemented using shared memory on the software host. While the software-implemented NPS may easily access the shared memory, access to the shared memory by the hardware-implemented NI is computationally expensive, such as when the NI accesses the shared memory to get data each time it sends a window probe packet.

### SUMMARY OF THE INVENTION

The present invention discloses the transmission of window probe packets, such as in TCP/IP-based networks, where the window packet probe payload is maintained by the network interface (NI) in a connection context field (CCF), such that the NI does not need to access shared memory to get data each time it sends the window probe packet.

In one aspect of the present invention a system is provided for facilitating communication between a sender computer and a recipient computer via a network, the system including a network interface (NI), a network protocol stack (NPS), a data memory for transferring data from the NPS to the NI for transmission to the recipient computer, a connection context field (CCF) for storing a byte of the data for transmission by the NI to the recipient computer as part of a window probe packet, and a decision maker for providing a sequence number associated with the byte for transmission by the NI to the recipient computer as part of the window probe packet.

In another aspect of the present invention the NI operates in a data transmission mode absent an indication that the recipient computer is unable to receive the data, where the NI transmits the data to the recipient computer.

In another aspect of the present invention the NI operates in a window probe mode subsequent to receiving an indication that the recipient computer is unable to receive the data, where the NI transmits the window probe packet to the recipient computer.

In another aspect of the present invention the CCF is maintained for a single data connection between the sender computer and the recipient computer.

In another aspect of the present invention each of a plurality of the CCFs is maintained for a corresponding one of a plurality of data connections between the sender computer and the recipient computer.

In another aspect of the present invention the CCF is operative to store the byte and its associated sequence number.

In another aspect of the present invention the NI is operative to package a segment of the data into a TCP/IP packet.

In another aspect of the present invention the window probe packet includes the last byte of the data most recently sent to the recipient computer, as well as the sequence number of the byte in a data stream of the data.

In another aspect of the present invention a method is provided for facilitating communication between a sender computer and a recipient computer via a network, the method including transferring data from a network protocol stack (NPS) to a network interface (NI) for transmission to the recipient computer, storing a byte of the data in a connection context field (CCF) for transmission by the NI to the recipient computer as part of a window probe packet, and providing a sequence number associated with the byte for transmission by the NI to the recipient computer as part of the window probe packet.

In another aspect of the present invention the method further includes a) assembling the window probe packet from the byte in the CCF and the sequence number, b) transmitting the window probe packet to the recipient computer, and c) performing steps a) and b) a plurality of times for the same byte and sequence number.

In another aspect of the present invention the method further includes operating in a data transmission mode absent an indication that the recipient computer is unable to receive the data, where the NI transmits the data to the recipient computer.

In another aspect of the present invention the method further includes operating in a window probe mode subsequent to receiving an indication that the recipient computer is unable to receive the data, where the NI transmits the window probe packet to the recipient computer.

In another aspect of the present invention the method further includes maintaining the CCF for a single data connection between the sender computer and the recipient computer.

In another aspect of the present invention the method further includes maintaining each of a plurality of the CCFs for a corresponding one of a plurality of data connections between the sender computer and the recipient computer.

In another aspect of the present invention the method further includes storing the byte and its associated sequence number in the CCF.

In another aspect of the present invention the method further includes packaging a segment of the data into a TCP/IP packet.

In another aspect of the present invention the storing step includes storing the last byte of the data most recently sent to the recipient computer, as well as the sequence number of the byte in a data stream of the data.

In another aspect of the present invention a computer program is provided embodied on a computer-readable medium, the computer program including a first code segment operative to transfer data from a network protocol stack (NPS) to a network interface (NI) for transmission to a recipient computer, a second code segment operative to store a byte of the data in a connection context field (CCF) for transmission by the NI to the recipient computer as part of a window probe packet, and a third code segment operative to provide a sequence number associated with the byte for transmission by the NI to the recipient computer as part of the window probe packet.

### BRIEF DESCRIPTION OF THE DRAWINGS

The present invention will be understood and appreciated more fully from the following detailed description taken in conjunction with the appended drawings in which:

FIG. 1A is a simplified pictorial illustration of a descriptor list, useful in understanding the present invention;

FIGS. 1B and 1C, taken together, is a simplified flow chart illustration of a method for entering window probe mode, useful in understanding the present invention;

FIG. 2A is a simplified flow chart illustration of a first method for creating window probe packets, useful in understanding the present invention;

FIG. 2B is a simplified flow chart illustration of a second method for creating window probe packets, useful in understanding the present invention;

FIG. 3A is a simplified pictorial illustration of a network interface with a connection context field, constructed and operative in accordance with a preferred embodiment of the present invention; and

FIG. 3B is a simplified flow chart illustration of a method for utilizing a connection context field to create window probe packets, operative in accordance with a preferred embodiment of the present invention.

### DETAILED DESCRIPTION OF PREFERRED EMBODIMENTS

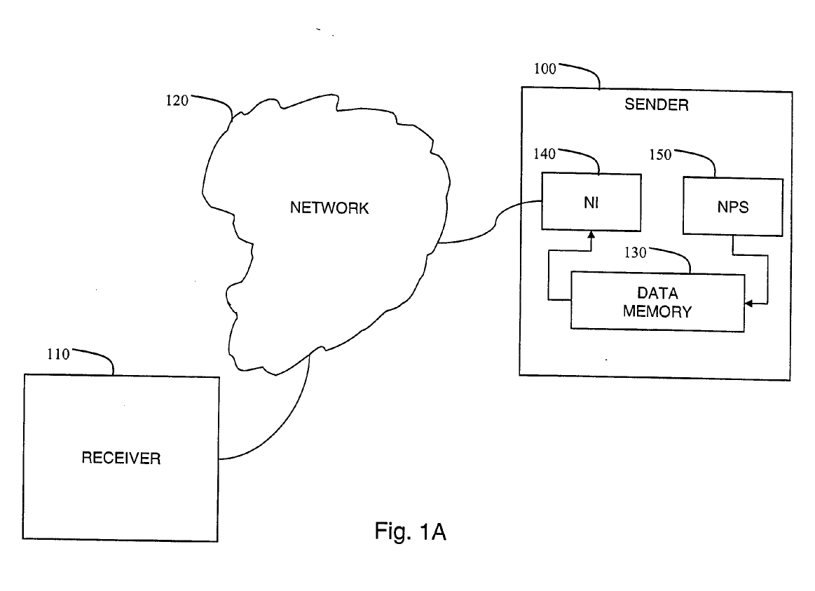

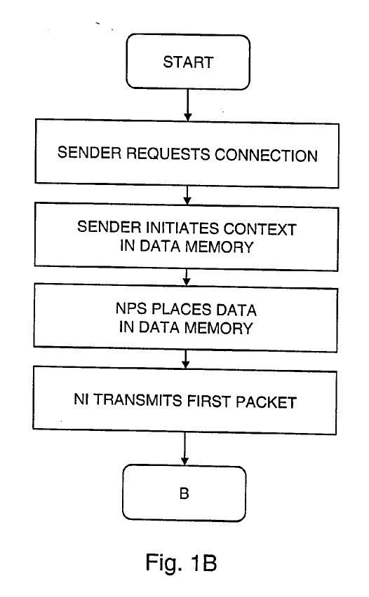

Reference is now made to FIG. 1A, which is a simplified pictorial illustration of a network communication system, useful in understanding the present invention, and FIGS. 1B and 1C, which, taken together, is a simplified flow chart illustration of a method for entering window probe mode, useful in understanding the present invention. In the method of FIG. 1B, a sender computer 100 requests a connection with a receiver computer 110 over a network 120, such as the Internet. Sender 100 typically employs a data memory 130 to facilitate communication between a network interface (NI) 140 and a network protocol stack (NPS) 150, both of which typically share data memory 130. NPS 150 then begins the process of data transmission by placing data into data memory 130 and requesting that NI 140 transmit the data over the connection. NI 140 then preferably enters a data transmission mode in which NI 140 packages segments of data retrieved from data memory 130 into packets, such as TCP/IP packets, and transmits the packets over network 120 to receiver 110.

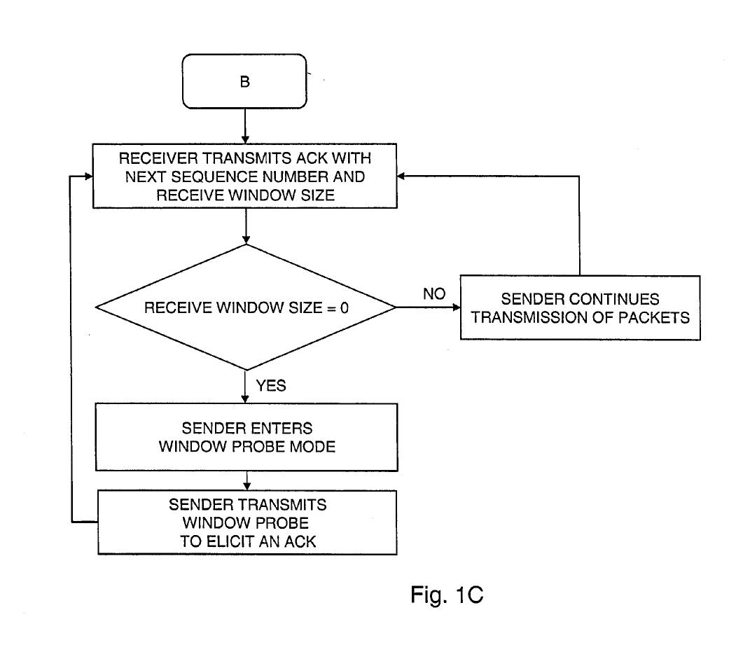

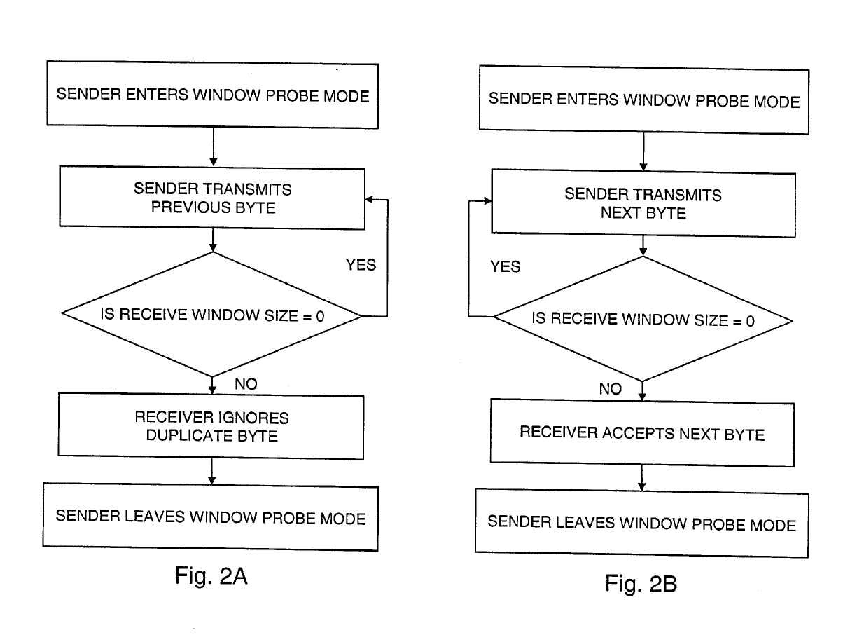

Receiver 110 typically transmits an ACK for each packet accepted, which preferably includes the packet sequence number identifying the received packet, and the size of receiver 110's receive window. NI 140 receives the ACK transmitted by receiver 110, and decides whether to change modes of operations based on the size of the receiver 110's receive window. If the size of the receive window is greater than zero or is at or above a predefined threshold, NI 140 continues in data transmission mode to retrieve data from data memory 130, create packets from the data, and transmit the packets to receiver 110. If the size of the receive window is equal to zero or is at or below a predefined threshold, NI 140 preferably enters window probe mode and transmits window probe packets designed to elicit an ACK from receiver 110, as described in more detail hereinbelow with reference to FIGS. 2-4. In window probe mode, NI 140 continues to analyze each ACK to determine the size of the receive window available on receiver 110, and, should the size of the receive window be greater than zero or be at or above a predefined threshold, NI 140 preferably exits window probe mode and returns to data transmission mode.

Reference is now made to FIG. 2A, which is a simplified flow chart illustration of a first method for creating window probe packets, useful in understanding the present invention, and to FIG. 2B, which is a simplified flow chart illustration of a second method for creating window probe packets, useful in understanding the present invention. In the method of FIG. 2A, NI 140 generates a window probe packet whose payload typically includes only the last byte of data most recently sent to receiver 110, as well as the sequence number of the byte in the data stream. For example, if the last byte of data transmitted represented the letter ‘W’ and was the 154^{th} byte in the sequence, the window probe packet will be composed of the sequence number 154 and a single-byte payload representing the letter ‘W’.

Alternatively, in the method of FIG. 2B, NI 140 generates a window probe packet whose payload typically includes only the next byte of data following the last byte of data most recently sent to receiver 110, as well as the sequence number of the next byte in the data stream. For example, if the last byte of data transmitted represented the letter ‘W’ and was the 154^{th} byte in the sequence, and the next byte in the sequence is the letter ‘H’, the window probe packet will be composed of the sequence number 155 and a single-byte payload representing the letter ‘H’.

Thus, in each of the methods of FIGS. 2A and 2B a single byte of data is utilized as the payload. The data is chosen such that receiver 110, upon receiving the byte of data, can process the data in the same way that it processes all data received, where the last/next byte of data will be ignored/accepted by receiver 110 as required.

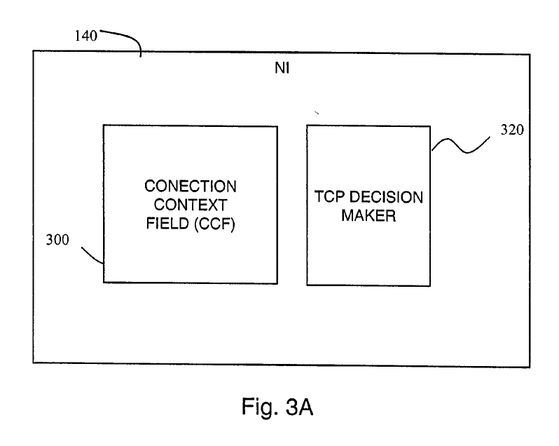

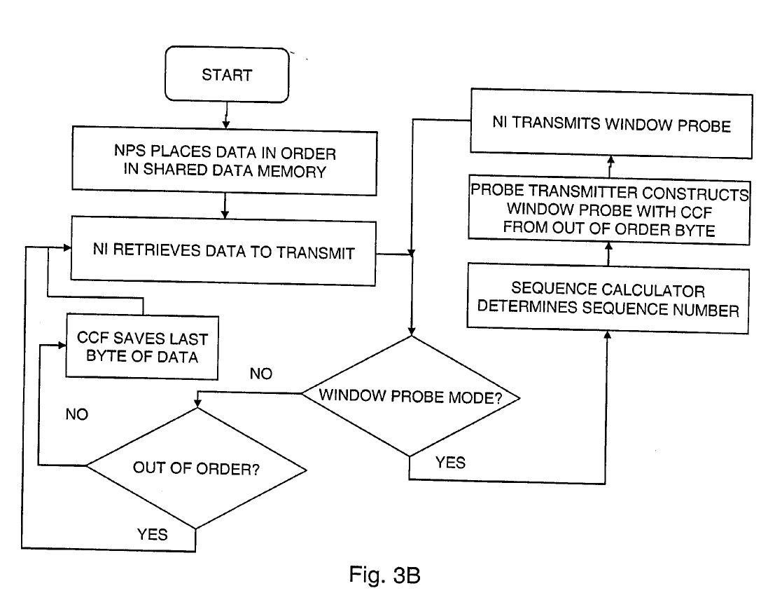

Reference is now made to FIG. 3A, which is a simplified pictorial illustration of a network interface with a connection context field, constructed and operative in accordance with a preferred embodiment of the present invention, and to FIG. 3B, which is a simplified flow chart illustration of a method for utilizing a connection context field to create window probe packets, operative in accordance with a preferred embodiment of the present invention. In the system of FIG. 3A, NI 140 preferably includes a connection context field (CCF) 300 for storing the last byte transmitted to receiver 110, and a decision maker 320 for determining whether or not each packet was previously sent and retaining the sequence number of new packets. NI 140 preferably constructs a window probe packet employing decision maker 320 to determine the sequence number of the packet and CCF 300 to determine the payload of the packet.

Thus in the method of FIG. 3B, when NI 140 is in data transmission mode, NI 140 processes data as described hereinabove with reference to FIGS. 1B and 1C, with the notable exception that the last byte of data transmitted is preserved in CCF 300, and the sequence number of each new packet is retained by decision maker 320. Thus, in the method of FIG. 3B, when NI 140 enters window probe mode, NI 140 is capable of constructing the window probe packet without accessing data memory 130. The information necessary to construct the window probe packet is available in CCF 300 and decision maker 320.

Decision maker 320 preferably identifies each packet as either ‘new’ or ‘old’ based on their payload. Packets containing newly transmitted data are identified as ‘new’, and packets containing retransmitted data are identified as ‘old.’ Furthermore, for each new packet, decision maker 320 preferably retains the sequence number of the new packet, and NI 140 preferably stores the last byte of the new packet in CCF 300.

While the above description refers to a single connection context field (CCF) maintained for a single connection, such as a TCP/IP connection, it is appreciated that a different CCF may be utilized for each of a number of different connections. It is further appreciated that while the above description refers to a single-byte CCF, a multi-byte CCF may be utilized, such as one that includes room for the storage of the byte sequence number, thus obviating the need for decision maker 320.

Packets may be sent out of sequence, creating an out-of-order packet flow under conditions well known in the art, such as may occur following TCP/IP timeouts of sent packets. When NI 140 is in window probe mode during an out-of-order packet flow, the window probe byte retrieved from CCF 300 for transmission is typically an out-of-order byte. After NI 140 exits window probe mode, and before it resumes data transmission mode, NI 140 preferably retrieves from sender 100 any bytes not yet successfully sent to receiver 110, following which NI 140 preferably re-enters data transmission mode and continues processing as described above.

NI 140 may utilize any well known methodology to determine when to retransmit data and thus enter an out-of-order packet flow state, such as a timeout expiration detection or fast-retransmit detection. A timeout expiration condition may occur when NI 140 detects that a pre-defined amount of time has elapsed since the last data transmission and/or last non-duplicate ACK arrival. For example, the round-trip time (RTT), defined as the time elapsed from transmission of a data packet until receipt of its associated ACK, may be measured for each packet sent. The first time a packet's RTT ACK is not received within a predefined time, such as 1 second, the packet is said to have timed out and is retransmitted. Should an ACK not be received for the same packet after the retransmission after a second predefined time, such as an exponential function of the first pre-defined time, continuing the previous example 2 seconds, the packet is retransmitted a second time. This process continues until the timeout reaches a predefined threshold, such as 60 seconds.

A fast-retransmit condition occurs when a pre-defined number of duplicate ACKs arrive, such as 3. The arrival of duplicate ACKs are typically triggered by an out-of-order data arrival at receiver 110, and are therefore interpreted as an indication of data loss.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A system for facilitating communication between a sender computer and a recipient computer via a network, the system comprising:
a network interface (NI);
a network protocol stack (NPS);
a data memory for transferring data from said NPS to said NI for transmission to said recipient computer;
a connection context field (CCF) for storing a byte of said data for transmission by said NI to said recipient computer as part of a window probe packet; and
a decision maker for providing a sequence number associated with said byte for transmission by said NI to said recipient computer as part of said window probe packet, wherein said NI includes said CCF and said decision maker.

2. A system according to claim 1 wherein said NI operates in a data transmission mode absent an indication that said recipient computer is unable to receive said data, wherein said NI transmits said data to said recipient computer.

3. A system according to claim 1 wherein said NI operates in a window probe mode subsequent to receiving an indication that said recipient computer is unable to receive said data, wherein said NI transmits said window probe packet to said recipient computer.

4. A system according to claim 1 wherein said CCF is maintained for a single data connection between said sender computer and said recipient computer.

5. A system according to claim 1 wherein each of a plurality of said CCFs is maintained for a corresponding one of a plurality of data connections between said sender computer and said recipient computer.

6. A system according to claim 1 wherein said CCF is operative to store said byte and its associated sequence number.

7. A system according to claim 1 wherein said NI is operative to package a segment of said data into a TCP/IP packet.

8. A system according to claim 1 wherein said window probe packet includes the last byte of said data most recently sent to said recipient computer, as well as the sequence number of said byte in a data stream of said data.

9. A method for facilitating communication between a sender computer and a recipient computer via a network, the method comprising:
transferring data from a network protocol stack (NPS) to a network interface (NI) for transmission to said recipient computer;
storing a byte of said data in said NI in a connection context field (CCF) for transmission by said NI to said recipient computer as part of a window probe packet; and
providing a sequence number associated with said byte for transmission by said NI to said recipient computer as part of said window probe packet.

10. A method according to claim 9 and further comprising:
a) assembling said window probe packet from said byte in said CCF and said sequence number;
b) transmitting said window probe packet to said recipient computer; and
c) performing steps a) and b) a plurality of times for the same byte and sequence number.

11. A method according to claim 9 and further comprising operating in a data transmission mode absent an indication that said recipient computer is unable to receive said data, wherein said NI transmits said data to said recipient computer.

12. A method according to claim 9 and further comprising operating in a window probe mode subsequent to receiving an indication that said recipient computer is unable to receive said data, wherein said NI transmits said window probe packet to said recipient computer.

13. A method according to claim 9 and further comprising maintaining said CCF for a single data connection between said sender computer and said recipient computer.

14. A method according to claim 9 and further comprising maintaining each of a plurality of said CCFs for a corresponding one of a plurality of data connections between said sender computer and said recipient computer.

15. A method according to claim 9 and further comprising storing said byte and its associated sequence number in said CCF.

16. A method according to claim 9 and further comprising packaging a segment of said data into a TCP/IP packet.

17. A method according to claim 9 wherein said storing step comprises storing the last byte of said data most recently sent to said recipient computer, as well as the sequence number of said byte in a data stream of said data.

18. A computer program embodied on a computer-readable medium, the computer program comprising:
a first code segment operative to transfer data from a network protocol stack (NPS) to a network interface (NI) for transmission to a recipient computer;
a second code segment operative to store a byte of said data in said NI in a connection context field (CCF) for transmission by said NI to said recipient computer as part of a window probe packet; and
a third code segment operative to provide a sequence number associated with said byte for transmission by said NI to said recipient computer as part of said window probe packet.
